(19) United States
(12) Patent Application Publication
(10) Pub. No.: US 2022/0160141 A1
(43) Pub. Date: May 26, 2022

(54) OSCILLATING SLEEP INDUCTION BED

(71) Applicant: Masamichi KAMEI, Tokyo (JP)

(72) Inventor: Masamichi KAMEI, Tokyo (JP)

(21) Appl. No.: 17/602,516

(22) PCT Filed: Feb. 20, 2020
(86) PCT No.: PCT/JP2020/006840

§ 371 Date: Oct. 8, 2021

(30) Foreign Application Priority Data
Apr. 12, 2019 (JP) 2019-076008
Feb. 13, 2020 (JP) 2020-022692

(51) Int. Cl. A47C 21/00; A47D 9/02

(52) U.S. Cl. CPC A47C 21/006; A47D 9/02

(57) ABSTRACT

An oscillating sleep induction bed of the present invention enables a person suffering from insomnia, etc., to efficiently fall asleep by means of slow lateral oscillation, which accompanies a gentle vertical motion, within a near-horizontal plane slightly curved into an arc shape, rather than by rotational motion or high-frequency vibratory motion. The bed is provided with a support section (2) having an upper-surface curved section (2a) configured such that the cross section perpendicular to the longitudinal direction of the bed forms a downwardly convex arc shape, an oscillating section (3) that oscillates along the upper-surface curved section (2a) of the support section (2) in the lateral direction of the bed, and a drive means for causing the oscillating section (3) to oscillate in the lateral direction of the bed. The curvature radius of the upper-surface curved section is 1.5≤r≤25 m. The horizontal amplitude d of the oscillating section (3) produced by the drive means is set to be variable within the specific range of 0 cm<d≤10 cm, and a vibration frequency f is set to be variable within the specific range of 0.1 Hz<f≤0.6 Hz.

### TECHNICAL FIELD

This invention relates to an oscillating sleep induction bed which is capable of promoting sleep induction for a user.

### BACKGROUND ARTS

Heretofore, a vibrating bed that imparts micro vibration using a vibrating device embedded in a mattress part of the bed and an oscillating bed that causes the bed itself to oscillate have been developed.

As one bed for medical use to prevent a patient with a serious disease or with one's body motion restricted for long periods from suffering complications caused by one's bedridden state, a patent document 1 below discloses a vertically vibratory type oscillating bed in which a single piece of extension/contraction drive means is mounted to each of a head side and a foot side in a longitudinal center position of the bed to rotationally move the bed upward and downward in the vertical direction.

In relation to a bed for medical use likewise, a patent document 2 below discloses an oscillating bed in which the upper end of an arm is fixedly attached to an output shaft of a reduction gear of a motor mounted to the underside of a mattress mounting rest frame, and when a roller at the tip of the arm is guided vertically along a vertical guide member in accordance with the normal/reverse rotation of the motor, the output shaft is caused to shake out to the right and left, and thus, the rest frame is rotationally moved in a silent and gentle manner around an oscillating axis line.

As one sleep-promoting oscillating bed, with which promotion of sleep is achieved by imparting comfortable oscillation necessary for sleep to the body of a person, while minimizing vertical oscillation to the head thereof, a patent document 3 below discloses a sleep-promoting oscillating bed which is provided with a bed base, an oscillating frame supported oscillatably by the bed base, a bed floor supported by the oscillating frame, and an oscillation drive means for driving the oscillating frame for oscillation together with the bed floor, wherein the oscillating frame has an oscillation center axis line that extends along the height direction of a user being in the posture of lying on one's back on the bed floor so as to longitudinally pass through the head of the user.

A patent document 4 below discloses an oscillating bed that comprises a base, an oscillating body supported in a reciprocally movable manner in the bed width direction, a drive tool mounted on the base to cause the oscillating body to move reciprocally, and a bed body on which a sleeping user is placed, wherein comfortable rolling stimulation and/or motion is imparted to the muscles and/or joints of the sleeping user centering on one's back to provide comfortable sleep, basically on condition that a back bed body part on which the back of the sleeping user is placed shall be moved reciprocally in the bed width direction.

A patent document 5 below discloses a sleep inducement function-equipped bed in which a vibration board equipped on the bed is provided with a continuous micro-vibration generator for generating continuous micro-vibration like vibration brought from a running train, for instance, and an intermittent single-shot vibration generator for generating single-shot vibration repeated at a substantially constant period like vibration generated at rail joints, for instance, wherein both the continuous micro-vibration and the intermittent single-shot vibration are allowed to compositely act on the human body being in a lying posture, thereby resulting in obtaining a satisfactory sleep inducement action.

In relation to a movable bed system for medical use which is capable of safely and silently changing the posture of a person to be cared, for instance, without disturbing good sleep of the person to be cared, a patent document 6 below discloses a movable bed system in which adjustment of an inclination angle of each part of a bed bottom formed being divided into right and left parts along the longitudinal direction is performed using a linear actuator.

As one oscillating bed for massaging and/or rehabilitation treatments and/or for promotion of sleep induction in condition where a user keeps one's posture lying down on the bed, a patent document 7 discloses a human body oscillating device that comprises a fixing section arranged in an installation place, an oscillated section arranged thereon, an oscillation drive section for causing the oscillated section to move reciprocally, a first slide mechanism for causing the oscillated section to oscillate relative to the fixing section along the direction of oscillation, a second slide mechanism for regulating horizontal shift of the oscillated section by a vertical plane, a control section for controlling each drive section, various sensors and an operation panel.

A non-patent document 1 below describes that, for verification of a change of awakening consciousness level and a relaxation effect resulting from impact of constantly periodical rhythm stimulation, based on an effect of helping an infant to fall asleep as having been experiencedly obtained by the time-honored and usually-conducted customs of stimulating one's back by means of soft-mannered tapping, one experiment of giving impact of rhythm stimulation of about 0.33 to 0.67 Hz (about 30 times per minute) to the back of each subject being in the posture of lying to the right was conducted for ten minutes with 43 healthy female students as the subjects, and as a result, it has been found that the experimental result showing a relaxed state is obtained and that a subjective relaxation effect is considered to be produced, while sedation of sympathetic nerve activities is suggested.

### PRIOR ART DOCUMENTS

### Patent Documents

Patent document 1: Japanese Patent Publication No. 3124453

Patent document 2: Japanese Patent Publication No. 3329787

Patent document 3: Japanese Patent Publication No. 4590238

Patent document 4: Japanese Patent Publication No. 5086696

Patent document 5: Japanese Unexamined Patent Application Publication No. 2004-024678

Patent document 6: Japanese Unexamined Patent Application Publication No. 2016-067429

Patent document 7: Japanese Unexamined Patent Application Publication No. 2018-139766

Non-Patent Document

Non-patent document 1: Sumi HIROI et al, 2010, Effects of Periodic Rhythm Stimulation for 10 Minutes on Awakening Consciousness Level, Academic Journal of Japanese Society of Nursing Art and Science, Vol.9, No. 2, pp 29 to 37

### SUMMARY OF THE INVENTION

### Problems to be Solved by the Invention

The oscillating beds as respectively disclosed in the patent documents 1 and 2 are constituted, as the bed for medical use, such as to be made movable rotationally in the longitudinal or lateral direction in order to prevent the bedridden patient from suffering bedsores and/or complications, for instance, whereas it is to be understood that these beds are not aimed at sleep induction.

The sleep-promoting oscillating bed as disclosed in the patent document 3 has a structure in which the oscillating frame with the bed floor mounted thereon is subjected to oscillation in the lateral direction by the oscillation drive means in state where the oscillating frame is axially supported by a support shaft of a side frame positioned at the front and rear ends of the bed through a triangular suspension arm. The oscillation drive means is constituted such that a brake motor fixedly supported by an intermediate part of a bottom frame of the bed base is used as a drive source to drive the oscillating frame for oscillation with a predetermined amplitude in the lateral direction through an eccentric plate, an eccentric shaft, a connecting rod and an oscillating arm, for instance.

In the case of the sleep-promoting oscillating bed as disclosed in the patent document 3, the bed floor on which the user is placed in the lying posture is designed such that the front and rear ends of the bed floor are only axially supported relative to the front and rear side frame support shafts through the triangular suspension arm, and hence, all loads would act on a connection part between the support shaft and the suspension arm of the bed floor, so that it becomes difficult to meet design standard for safety because of the occurrence of an increase in bending stress and/or shearing stress acting on the bed floor or the oscillating frame when the user turns over toward one side of the bed in one's sleep.

Besides, for the oscillation drive means used for the sleep-promoting oscillating bed as disclosed in the patent document 3, there exist the problems that a large gap space would be caused between the bed base in a lower position and the bed floor in an upper position, in addition to upsizing of the bed as a whole, because of the need of a large space for installation of the brake motor, the eccentric plate, the eccentric shaft, the connecting rod, the oscillating arm and the oscillating frame.

The oscillating bed as disclosed in the patent document 4 is to provide the comfortable sleep thanks to a massaging and/or blood circulation improving effect, for instance, which is produced by means of rolling stimulation and/or motion of 1 to 10 mm in the amount of eccentricity from the center of rotation centering on the back of the user and 400 to 800 rpm in the rotation speed of an eccentricity means, in which case, however, any sleep inducement effect for a person suffering from insomnia, for instance, would be hardly to be expected, even if the massaging effect caused by a high-frequency micro-vibratory motion is obtained.

The sleep inducement function-equipped oscillating bed as disclosed in the patent document 5 makes use of the continuous micro-vibration generator for applying the vibration like the vibration brought from the running train, in combination with the intermittent single-shot vibration generator for applying the vibration like the vibration generated at the rail joints, in which case, however, it is not clear how low-frequency vibration is applied to which part of the human body by the vibration generator, and besides, the resultant effect is not clearly stated.

The movable bed system as disclosed in the patent document 6 is used as a medical or caregiving bed to allow the patient and/or the person to be cared on the bed to change one's posture to the lateral position safely and silently using the linear actuator, whereas it is to be understood that this bed system is not aimed at promotion of sleep induction for the user.

The oscillating bed as disclosed in the patent document is constituted such that the means for regulating the horizontal shift of the oscillated section is included in a structure for generating oscillation in the longitudinal direction of the bed, in which case, however, any oscillation other than the longitudinal oscillation is not taken into consideration.

An object of the present invention is to provide, as one oscillating bed for sleep induction, a sleep induction bed that enables a person suffering from insomnia, for instance, to efficiently fall asleep by means of slow lateral oscillation, which accompanies a gentle vertical motion, within a near-horizontal plane slightly curved into an arc shape, rather than by rotational motion or high-frequency vibratory motion.

### Means for Solving the Problems

An oscillating sleep induction bed of the present invention comprises a support section having an upper-surface curved section configured such that the cross section perpendicular to the longitudinal direction of the bed forms a downwardly convex arc shape, an oscillating section that oscillates along the upper-surface curved section of the support section in the lateral direction of the bed, and a drive means for causing the oscillating section to oscillate in the lateral direction of the bed, wherein the curvature radius of the upper-surface curved section is 1.5 m≤4≤25 m, and the horizontal amplitude d of the oscillating section produced by the drive means is set to be variable within the specific range of 0 cm<d≤10 cm, while the vibration frequency f is set to be variable within the specific range of 0.1 Hz<f ≤0.6 Hz.

In the oscillating sleep induction bed of the present invention, a mattress used for a normal bed can be installed on the oscillating section. In this case, it is allowable that the mattress may be placed on the oscillating section directly or indirectly through some interposition or a mattress fixing means in therebetween, for instance.

While the support section in the oscillating sleep induction bed of the present invention can be the equivalent of a bed body such as a bed bottom positioned at a lower part of the normal bed, it is allowable also that the support section may be installed separately at an upper part of the bed body. In either case, it is noted that the present invention is based on the assumption that the upper-surface curved section is formed on an upper surface of the support section.

Meaning of the amplitude d being within the specific range of 0 cm<d≤10 cm is that the amplitude is allowed to be designed variably within this specific range such as to give 1.5 cm≤d≤8 cmor 2 cm ≤d≤6 cm by designing, for instance. Likewise, meaning of the vibration frequency f being within the specific range of 0.1 Hz<f≤0.6 Hz is that the vibration frequency is allowed to be designed variably within this specific range such as to give 0.15 Hz≤f≤0 or 0.2 Hz≤f≤0.4 Hz by designing, for instance.

It is noted that the amplitude d stated herein indicates half amplitude and is supposed to be subjected to displacement by 2d in entirety for a period T. Meanwhile, a time taken for shift from one end to the other (a distance of 2d) of the vibration amplitude is T/2=(½ f) seconds.

It is allowable that operation for the oscillating device drive means or for an associated power transmitting mechanism may be performed to be adjustable within this specific range by means of switching of switch or dial setting in accordance with the physical characteristics and/or the physical conditions and feelings of a certain day on a user basis. It is allowable also that operation for automatic stop after the lapse of a certain period of time may be performed by means of setting of a timer device, for instance.

Unlike the conventional bed which is rotationally moved in the lateral or longitudinal direction around the body of the user being in the posture of lying down on the bed or applies stimulation caused by a vibration generator that imparts a high-frequency vibratory motion, it is to be understood that the oscillating sleep induction bed of the present invention is to provide slow oscillation normally in the lateral direction of the body of the user being in the lying posture, within a near-horizontal plane slightly curved into an arc shape, in condition where the user keeps one's posture lying down on the bed in principle, thus allowing the user to be induced to sleep naturally and efficiently by means of less stimulative and silent oscillation of a frequency order on a person's respiration or heartbeat level.

It can be considered that the amplitude d (the half amplitude) in the reciprocating motion of the oscillating section is limited to at most about 10 cm from the viewpoint of an effect of providing the comfortable sleep in safety, and hence, it is allowable that adjustment of the amplitude may be performed preferably within the range of about 1.5 cm ≤d≤8 cm. This is because excessively small amplitude would bring about a small oscillation effect, whereas excessively large amplitude would fail to keep a resting condition due to the occurrence of application of a force corresponding to an acceleration component in relation with the vibration frequency. Meanwhile, when the amplitude d is about 8 cm or 10 cm, it is relatively easy for execution of designing even in consideration of the relation with the drive mechanism, and besides, the occurrence of contact with some object around the bed, for instance, will hardly cause any factor of the problem.

It can be considered that although being dependent on the relation with the amplitude, the vibration frequency f in the reciprocating motion of the oscillating section is limited to at most about 0.7 Hz from the viewpoint of an effect of providing the comfortable sleep in safety, and accordingly, shall be 0.1 Hz<f≤0.6 Hz in the present invention. In this case, it is allowable that adjustment of the vibration frequency may be performed preferably within the range of about 0.15 Hz≤f≤0.5 Hz, more preferably, about 0.2 Hz ≤f≤0.4 Hz. This is because excessively small vibration frequency would bring about a small oscillation effect, whereas excessively large vibration frequency would fail to keep a resting condition due to the occurrence of application of a force corresponding to an acceleration component in relation with the vibration frequency.

For instance, 0.15 Hz as stated the above indicates that 9 times of reciprocating motion (9T) may occur for one minute so that the frequency of timings of shift to one side (the half period of vibration) will be 18 times for one minute, thus being considered to be on the same level as an adult's normal respiration frequency. Likewise, 0.5 Hz as stated the above indicates that 30 times of reciprocating motion may occur for one minute so that the frequency of timings of shift to one side (the half period of vibration) will be 60 times for one minute, thus being considered to be on the same level as a heartbeat frequency in a resting condition. Thus, this frequency vibration range can be considered to be preferable based on such factors as the experimental result showing the awakening consciousness level reduction caused by the rhythm stimulation of 0.33 to 0.67 Hz as previously described in the non-patent document 1, a relaxation effect and/or a sense of security given to an unborn baby by rhythmical heartbeats of one's mother being in a healthy and emotionally stable state and some situation of feeling comfortable with clapping of hands in rhythm, for instance.

It is noted that the experiment as previously described in the non-patent document 1 is not based on the reciprocating motion like the oscillation in the present invention but on the timing of impact, and hence, in terms of the timing of stimulation, it is close to the timing of stimulation (0.15 Hz×2 to 0.5 Hz×2, for instance) caused by the oscillation in the present invention.

In the oscillating sleep induction bed of the present invention, the reason why the curvature radius of the upper-surface curved section of the support section is 1.5 m 25 m is that when assuming that the oscillating section is the weight of a pendulum supposed to swing along the upper-surface curved section and that the curvature radius is a pendulum length, minimization of a drive force of the drive means can be achieved by the manner in which the frequency of forcible oscillation produced by the drive means is synchronized with a pendulum frequency or alternatively, set to be a frequency close to the pendulum frequency. In other words, synchronizing the frequency of forcible oscillation produced by the drive means with the pendulum frequency would cause the oscillating section to oscillate along the upper-surface curved section with a slight drive force, thus resulting in allowing a compact-sized and small-output drive means to be used for causing the oscillating section to oscillate.

The pendulum frequency when a pendulum swing width is small can be expressed as

f=ω/2π=(g/|)^{1/2}/2π (1)

where f is pendulum frequency (1/s), ω is angular frequency (rad/s), g is gravitational acceleration (9.8 m/s²), and | is pendulum length (m).

From the above expression (1), the pendulum length | can be given as

|=g/(2π×f)² (2)

Substitution of f (the vibration frequency)=0.10 Hz into the expression (2) gives

|≈9.8/(2×3.14×0.10)²≈24.87 m

Likewise,

substitution of f=0.15 Hz gives|≈11.05 m

substitution of f=0.20 Hz gives|≈6.21 m

substitution of f=0.25 Hz gives|≈3.70 m

substitution of f=0.30 Hz gives|≈2.76 m

substitution of f=0.40 Hz gives|≈1.55 m

substitution of f=0.50 Hz gives|≈0.99 m, and

substitution of f=0.60 Hz gives|≈0.69 m.

However, it should be noted that the lower limit of the curvature radius R of the upper-surface curved section in the present invention is 1.5 m, because of the fact that the upper-surface curved section of the support section when designed such that its curvature radius R corresponding to the pendulum length | is shorter than 1.5 m would provide the disadvantages of being not always easy to manufacture the support section with such upper-surface curved section and of impairing the stability of installation of the mattress or futon mattress, together with the stability of the user being in the posture of lying down thereon. It should be noted also that the upper limit of the curvature radius R of the upper-surface curved section is 25 m as being substantially equivalent to the length | of the pendulum with the frequency f of 0.10 Hz, because of no need for perfect synchronization.

In the oscillating sleep induction bed of the present invention, it is allowable that the oscillating section may be supported relative to the support section through a sliding surface formed using a low friction material. Specifically, it may be possible to apply a structure in which a stainless steel plate is mounted to an upper surface of the support section, while a fluorine resin-made sheet or panel is mounted to a lower surface of the oscillating section, for instance, like sliding supports for use in a seismic isolation device of a building, for instance.

Interposition of the sliding surface allows frictional resistance to be reduced even on a surface of contact between the support section and the oscillating section, thereby resulting in allowing the compact-sized and small-output drive device to be used for producing oscillation. Meanwhile, enlargement of a contact area of the sliding surface allows a vertical force (a load of the bed and/or of the human body, for instance) applied to the oscillating section and the support section to be supported stably.

Moreover, as one means for reducing the frictional resistance on the surface of contact between the support section and the oscillating section, it is allowable also that use may be made of a structure for supporting the oscillating section through a plurality of one-way rollers or omni-directionally functioning ball rollers.

Otherwise, a stable support structure can be obtained also even by the manner in which two or more guide rails extending in the lateral direction along an upper curved surface of the upper-surface curved section of the support section are installed to cause the oscillating section to slide along the guide rails. In this case, use of a structure for supporting the oscillating section through bearings interposed on the guide rail sliding surface allows the effects of friction, for instance, to be minimized, thereby providing smooth oscillation.

As the drive means used for the oscillating sleep induction bed of the present invention, use can be made of a linear servo motor (inclusive of a linear actuator and a shaft motor, for instance), or alternatively, a drive means equipped with a ball screw and a rotary type motor for imparting a rotational motion to the ball screw.

In use of the linear servo motor or the ball screw, a horizontal oscillating motion of the oscillating section can be achieved in the form of a linear reciprocating motion produced by a compact-sized mechanism, and besides, the amplitude and/or the vibration frequency can be controlled to be variable with ease. Even when a plurality of linear servo motors or ball screws are arranged, it is easy to perform control with these linear servo motors or ball screws synchronized with each other.

While the linear servo motor or ball screw is basically to control the linear reciprocating motion, it is to be understood that use of the linear servo motor in combination with a link mechanism allows the oscillating section to oscillate along the upper-surface curved section of the support section in the lateral direction of the bed. Alternatively, it is allowable also that a track itself of the linear servo motor may be formed in an arc shape in conformity with the upper-surface curved section of the support section.

Alternatively, a winch mechanism may be utilized as the drive means. For instance, it may be possible to apply a structure in which a winch device is attached to a support section side, while the tip of a winch wire is attached to an oscillating section side through direction-changing pulleys, thus causing the oscillating section to oscillate along the upper-surface curved section of the support section by driving the drive device.

Moreover, it is allowable also that a load of the drive means may be reduced by jointly using a configuration in which the oscillating section is hung and supported through a hanging means for supporting the oscillating section in a pendulum-like manner, such that a pendulum rolling circle corresponds to the upper-surface curved section of the support section.

Otherwise, it is allowable also that the reciprocating motion may be controlled electromagnetically in state where the oscillating section is magnetically levitated from the support section using a magnetic levitation induction-type device.

### EFFECTS OF THE INVENTION

Unlike the conventional bed which is rotationally moved in the lateral or longitudinal direction around the body of a user being in the posture of lying down on the bed or applies stimulation caused by a vibration generator that imparts a high-frequency vibratory motion, it is to be understood that the oscillating sleep induction bed of the present invention is to provide slow oscillation normally in the lateral direction of the body of the user being in the lying posture, within a near-horizontal plane slightly curved into an arc shape, in condition where the user keeps one's posture lying down on the bed in principle, thus allowing the user to be induced to sleep naturally and efficiently by means of less stimulative and silent oscillation of a frequency order on a person's respiration or heartbeat level.

When the user before subjected to oscillation keeps one's posture lying down on the center of the bed in state where one's body is stretched, an upper curved surface is lowest at the center in the bed width direction so as to become slightly high at both sides thereof, so that the oscillating sleep induction bed of the present invention can be used in a restful feeling because the user does not perceive such feeling as rolling over on the bed due to inclination, with respect to the lateral oscillation which accompanies a gentle vertical motion along the upper curved surface.

In the oscillating sleep induction bed of the present invention, the curvature radius of the upper-surface curved section is 1.5 m≤r≤25 m, and the vibration frequency f produced by the drive means is set to be variable within the specific range of 0.1 Hz<f≤0.6 Hz. Accordingly, when assuming that the oscillating section is the weight of a pendulum supposed to swing along the upper-surface curved section, the frequency of forcible oscillation produced by the drive means and the pendulum frequency can be controlled to have a synchronous relationship or a relationship close thereto, thus allowing the oscillating section to oscillate along the upper-surface curved section with a slight drive force, thereby resulting in allowing a compact-sized and small-output drive device to be used for causing the oscillating section to oscillate.

### BRIEF DESCRIPTION OF THE DRAWINGS

FIG. 1 is a sectional view in the section perpendicular to the longitudinal direction of an oscillating sleep induction bed according to the present invention to show the basic principle of this bed.

FIG. 2 is a sectional view in the section perpendicular to the longitudinal direction of the oscillating sleep induction bed according to the present invention to show one embodiment of this bed.

FIG. 3 is a sectional view in the section perpendicular to the longitudinal direction of the oscillating sleep induction bed according to the present invention to show another embodiment of this bed.

FIG. 4 is a sectional view in the section perpendicular to the longitudinal direction of the oscillating sleep induction bed according to the present invention to show a further embodiment of this bed.

FIG. 5 is a plan view partially showing a support section in which ball rollers are used as a support structure of an oscillating section in the present invention.

FIG. 6 is a perspective view showing one embodiment in which guide rails and support members provided through bearings are used as the support structure of the oscillating section in the present invention.

FIG. 7 is a schematic view showing one embodiment in which a linear servo motor and a link mechanism are used in combination as a drive means in the present invention.

FIG. 8 is a schematic view showing one embodiment in which a cylinder-type actuator is used as the drive means in the present invention.

FIG. 9 is a sectional view showing one embodiment of a bed oscillating device according to the present invention.

FIG. 10 is a schematic sectional view showing one embodiment concerning an installation position of the bed oscillating device according to the present invention.

FIG. 11 is a schematic sectional view showing another embodiment concerning the installation position of the bed oscillating device according to the present invention.

### MODE FOR EMBODYING THE INVENTION

Hereinafter will be described the present invention with reference to the attached drawings.

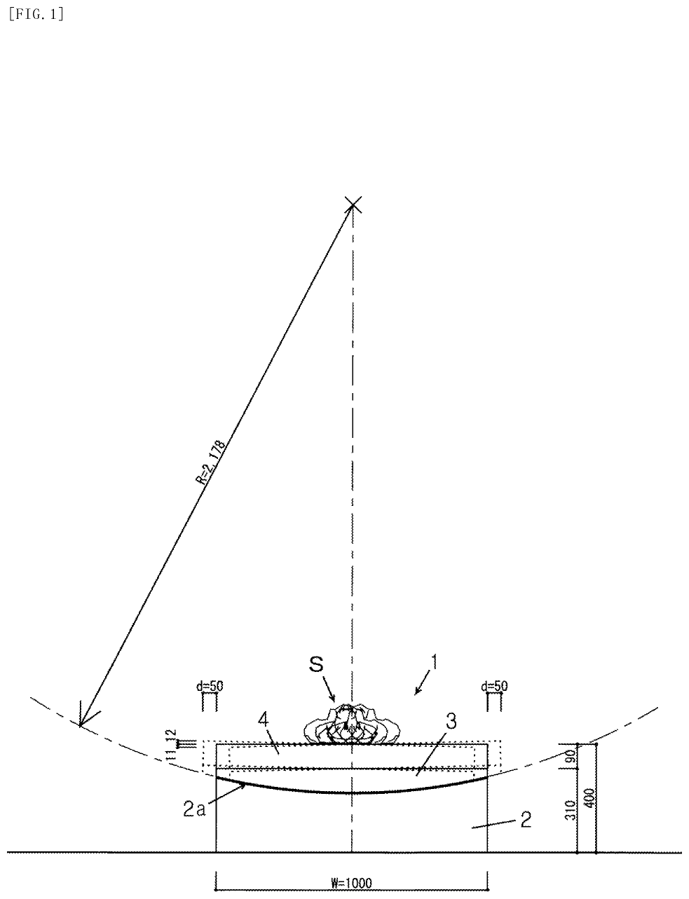

FIG. 1 shows a basic principle of the present invention, wherein an oscillating sleep induction bed 1 according to the present invention is provided with a support section 2 having an upper-surface curved section 2a configured such that the cross section perpendicular to the longitudinal direction of the bed forms a downwardly convex arc shape, an oscillating section 3 that oscillates along the upper-surface curved section 2a of the support section 2 in the lateral direction of the bed 1, and a drive means (not shown in FIG. 1) for causing the oscillating section 3 to oscillate in the lateral direction of the bed 1.

In FIG. 1, the oscillating sleep induction bed is shown in a simplified form based on the assumption that the bed is in the state where a mattress 4 of 90 mm in thickness is placed on the oscillating section 3, provided that a bed width W is 1000 mm in consideration of a width close to a common-type single bed width. If calculating on condition that the curvature radius of the upper-surface curved section 2a of the support section 2 is 2178 mm and that a half amplitude d is 50 mm, the result would be that the occurrence of shift by 50 mm (the half amplitude) in the horizontal direction is supposed to cause one end of the mattress 4 to lift upward by about 12 mm, while causing the opposite end thereof to lower by about 11 mm.

Incidentally, when assuming that the oscillating section 3 is the weight of a pendulum supposed to swing along the upper-surface curved section 2a and that the curvature radius R is a pendulum length |, a pendulum frequency f to a pendulum length | is given as f=0.356 Hz. Thus, if application of a drive force from the drive means could be performed at a vibration frequency as much as about the pendulum frequency, it would be possible to produce oscillation with a small drive force. However, it should be noted that in fact, frictional resistance in the upper-surface curved section 2a, for instance, has to be taken into consideration.

In condition where a user S keeps one's posture lying down on the mattress 4, the occurrence of shift of the oscillating section 3 by 50 mm in the horizontal direction to the right or left follows that shift of the user S also by 50 mm in the horizontal direction to the right or left occurs, in which case, a gentle vertical motion shall be caused in the vertical direction although being considered to be a slight motion as compared with the motion at the end of the mattress 4.

Unlike the conventional bed which is rotationally moved in the lateral or longitudinal direction around the body of the user being in the posture of lying down on the bed or applies stimulation caused by a vibration generator that imparts a high-frequency vibratory motion, it is to be understood that the oscillating sleep induction bed of the present invention is to provide slow oscillation normally in the lateral direction of the body of the user S being in the lying posture, within a near-horizontal plane slightly curved into an arc shape, in condition where the user keeps one's posture lying down on the bed in principle, thus allowing the user to be induced to sleep naturally and efficiently by means of less stimulative and silent oscillation of a frequency order on a person's respiration or heartbeat level.

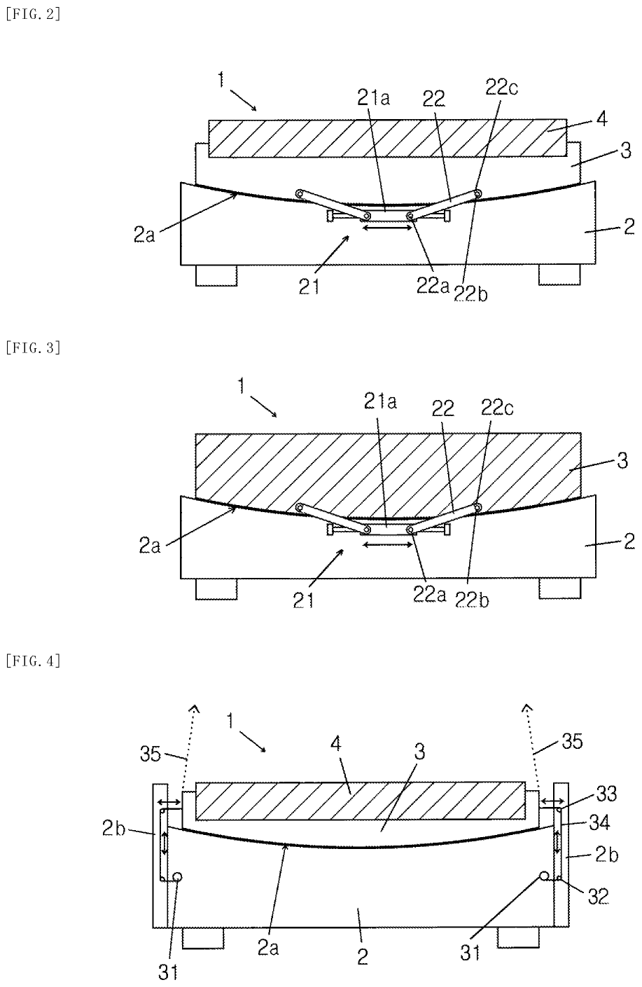

FIG. 2 shows one embodiment of the oscillating sleep induction bed of the present invention, wherein a surface of contact between the upper-surface curved section 2a of the support section 2 and the oscillating section 3 is formed in the shape of an arc-shaped sliding surface using a low friction material such as a combination of a stainless steel plate and a fluorine resin, for instance, to allow the oscillating section 3 to oscillate in a low friction state along the sliding surface-forming upper surface of the upper-surface curved section 2a.

For the drive means, a linear servo motor 21 is mounted to a support section 2-side to cause the oscillating section 3 to oscillate through a link 22 at a predetermined vibration frequency f and a predetermined amplitude d. The link 22 has one end rotatable around a pin 22a at the movable section 21a-side of the linear servo motor 21, and the other end thereof is connected to the oscillating section 3-side through a pin 22b. A lateral oscillating motion of a movable section 21a of the linear servo motor 21 is converted into an arcuate oscillating motion through the link 22 by the pin 22b moving within a guide groove 22c provided at the end of the link 22.

As for the vibration frequency f and the amplitude d, while being as previously stated in the paragraph of MEANS FOR SOLVING THE PROBLEMS, the amplitude d is set to be adjustable preferably within the range of 1.5 cm≤d≤8 cm, while the vibration frequency f is set to be adjustable preferably within the range of 0.15 Hz≤d≤0.5 Hz or 0.2 Hz≤f≤0.4 Hz, for instance, and hence, adjustment of the vibration frequency and the amplitude in accordance with the user S and/or use of a timer function and other control mechanisms in combination can be achieved by remote-control operation, for instance.

Namely, it is allowable that operation for the oscillating section drive means or for an associated power transmitting mechanism may be performed to be adjustable within this specific range by means of switching of switch or dial setting in accordance with the physical characteristics and/or the physical conditions or feelings of a certain day on a user basis. It is allowable also that operation for automatic stop after the lapse of a certain period of time may be performed by means of setting of a timer device, for instance.

FIG. 3 shows another embodiment of the oscillating sleep induction bed of the present invention. While the embodiment shown in FIG. 2 indicates the bed in which the mattress 4 is placed on the oscillating section 3, the embodiment shown in FIG. 3 is meant to indicate that the oscillating section 3 and the mattress are formed into an integral unit by means of incorporating the mattress into the oscillating section 3, for instance. A drive mechanism in this embodiment is the same as that in the embodiment shown in FIG. 2, and hence, a description thereof will be omitted.

FIG. 4 shows, as a further embodiment of the oscillating sleep induction bed of the present invention, one constitution in which a winch mechanism is used for the drive means. In this embodiment, a winch device 31 is attached to a support section 2-side, while the tip of a winch wire 34 is attached to an oscillating section 3-side through direction-changing pulleys 32, 33, thus causing the oscillating section 3 to oscillate along the upper-surface curved section 2a of the support section 2 by driving the winch device 31.

The embodiment shown in FIG. 4 is similar to the embodiments shown in FIGS. 2 and 3 in that the surface of contact between the upper-surface curved section 2a of the support section 2 and the oscillating section 3 is formed in the shape of the arc-shaped sliding surface using the low friction material to allow the oscillating section 3 to oscillate in the low friction state along the sliding surface-forming upper surface of the upper-surface curved section 2a.

Besides, the oscillating sleep induction bed in this embodiment makes use of a hanging material 35 jointly so as to allow the hanging material 35 to bear the oscillating section 3 and part of an upper load including a load of the mattress 4 placed thereon and/or of the user or the futon mattress, for instance. Although not shown in FIG. 4, an upper part of the hanging material 35 is connected to a separately installed support frame body or a ceiling, for instance.

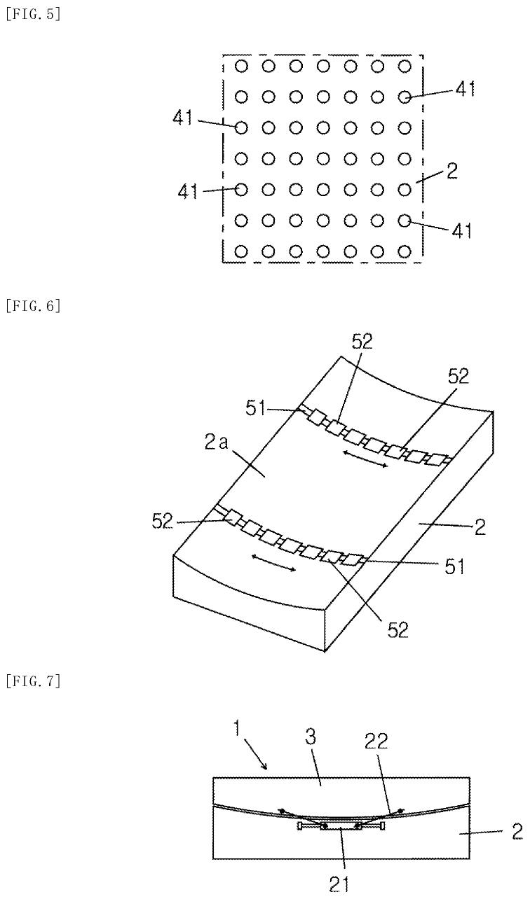

FIG. 5 partially shows the support section 2 in which ball rollers 41 are used for the upper-surface curved section 2a of the support section 2, as a support structure of the oscillating section in the present invention. Interposition of the ball rollers 41 allows frictional resistance to be reduced on the surface of contact between the support section 2 and the oscillating section, thereby resulting in providing smooth oscillation for the oscillating section 3 to which the upper load is applied.

Likewise, FIG. 6 shows, as a structure for providing smooth oscillation for the oscillating section, one embodiment in which the upper-surface curved section 2a of the support section 2 is provided with an arc-shaped guide rail 51 formed in conformity with the upper-surface curved section 2a and a plurality of support panels 52 that slide along the guide rail 51 through bearings (not shown), and the oscillating section 3 is fixed onto the support panels 52.

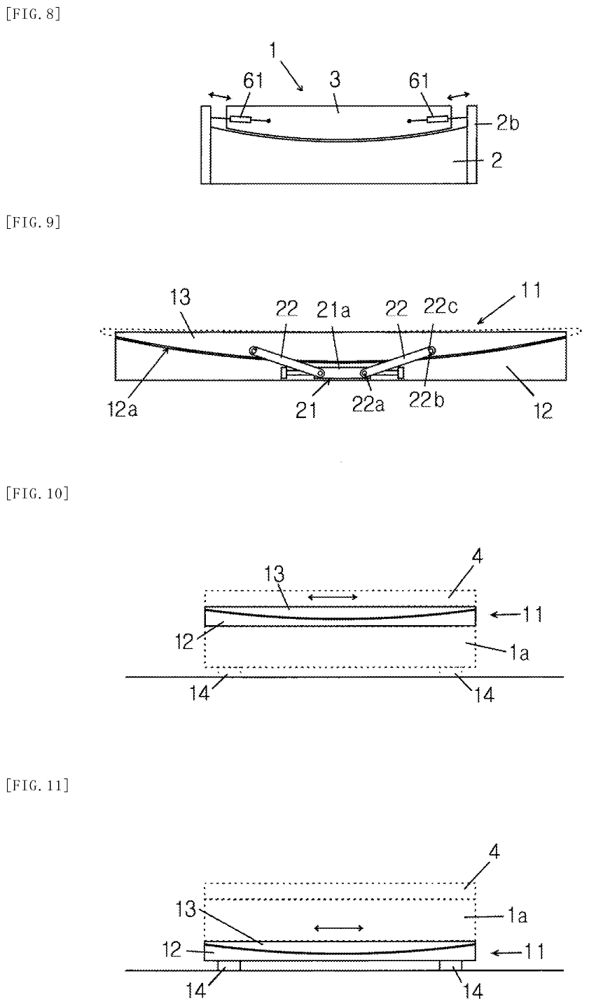

Although not shown in FIG. 6, a drive mechanism in this embodiment can make use of a drive mechanism as shown in FIGS. 7 and 8 described below, the drive mechanism utilizing the winch device previously shown in FIG. 4 or a magnetic levitation induction type drive mechanism, for instance.

FIG. 7 is a schematic view showing one embodiment in which the linear servo motor 21 and the link 22 are used in combination as the drive means, and it is noted that the embodiments previously shown in FIGS. 2 and 3 are in relation to this type.

The linear servo motor 21 and the link mechanism may be installed at two places, that is, a front end (or a user head side) and a rear end (or a user foot side) of the bed, for instance, wherein it can be considered that these are synchronized with each other and controlled. In this case, it is relatively easy for drive mechanism installation, whereas the presence of two driving mechanisms results in the need for control with these driving mechanisms synchronized with each other.

Meanwhile, it may be possible also to apply a structure in which a concave section is provided in the center of the support section 2, and the drive mechanism is installed within the concave section to allow an upper part of the link 22 to be housed in the oscillating section 3. In this case, the number of drive mechanisms can be reduced to one, whereas the structure of the support section 2 and/or the oscillating section 3 becomes complicated.

FIG. 8 is a schematic view showing one embodiment in which a hydraulic cylinder-type actuator 61 is used as the drive means, wherein use is made of a structure in which the support section 2 is provided with a rise part 2b, and the actuator 61 is attached between the rise part 2b and the oscillating section 3 to produce oscillation.

While the structure on the whole of the bed as the oscillating sleep induction bed 1 has been described in FIGS. 1 to 8, it is allowable also that a bed oscillating device 1A may be incorporated as a single unit into an existing bed, as shown in FIG. 9.

A bed oscillating device 11 shown in FIG. 9 is provided with a support device 12 having an upper-surface curved section 12a configured such that the cross section perpendicular to the longitudinal direction of the bed forms a downwardly convex arc shape, an oscillating panel 13 that oscillates along the upper-surface curved section 12a of the support device 12 in the lateral direction of the bed, and a drive means which is composed of a linear servo motor 21 and a link 22 to cause the oscillating panel 13 to oscillate in the lateral direction of the bed, wherein the horizontal amplitude d of the oscillating panel 13 produced by the drive means is set to be variable within the specific range of 0 cm<d≤10 cm, while the vibration frequency f is set to be variable within the specific range of 0.1 Hz<f≤0.6 Hz.

As for the support structure of the oscillating panel 13, various types of systems therefor may be applied, such as a system of using the sliding surface, that of supporting though the plurality of rollers or ball rollers and that of using the guide rail in combination with the bearings, for instance, similarly to the support structures having been described in FIGS. 1 to 8. As for the drive mechanism, various types of systems therefor may be applied, such as a system of using the linear servo motor or cylinder-type actuator in combination with the link mechanism, that of utilizing the winch device and that of using the magnetic levitation induction-type device, for instance.

FIG. 10 schematically shows one embodiment concerning installation of the bed oscillating device 11 so as to be positioned between a bed body la and the mattress 4. In the embodiment shown in FIG. 10, leg parts 14 are provided below the bed body 1a.

FIG. 11 shows another embodiment concerning installation of the bed oscillating device 11 so as to be positioned between a floor surface and the bed body 1a. While in this embodiment, the leg parts 14 are also provided on a lower surface of the bed oscillating device 11, it may not always be necessary to provide the leg parts 14 in both the embodiments shown in FIGS. 10 and 11.

### EXPLANATION OF REFERENCE NUMERALS

S . . . User,
1 . . . Oscillating bed, 1a . . . Bed body, 2 . . . Support section, 2a . . . Upper-surface curved section, 2b . . . Rise part, 3 . . . Oscillating section, 4 . . . Mattress,
11 . . . Bed Oscillating device, 12 . . . Support device, 12a . . . Upper-surface curved section, 13 . . . Oscillating panel, 14 . . . Leg part,
21 . . . Linear servo motor (Drive device), 21a . . . Operating part,
22 . . . Link, 22a . . . Pin, 22b . . . Pin, 22c . . . Guide groove,
31 . . . Winch device, 32 . . . Pulley, 33 . . . Pulley, 34 . . . Winch wire,
35 . . . Hanging material,
41 . . . Ball roller,
51 . . . Guide rail, 52 . . . Support panel,
61 . . . Actuator

1. 1 An oscillating sleep induction bed comprising:
a support section having an upper-surface curved section configured such that the cross section perpendicular to the longitudinal direction of the bed forms a downwardly convex arc shape;
an oscillating section that oscillates along said upper-surface curved section of said support section in the lateral direction of the bed; and
a drive means for causing said oscillating section to oscillate in the lateral direction of the bed;
wherein the curvature radius of said upper-surface curved section is 1.5 m≤r≤25 m; and
the horizontal amplitude d of said oscillating section produced by said drive means is set to be variable within the specific range of 0 cm≤d≤10 cm, while a vibration frequency f is set to be variable within the specific range of 0.1 Hz<f≤0.6 Hz.

2. The oscillating sleep induction bed according to claim 1, wherein a mattress is placed directly or indirectly on said oscillating section.

3. The oscillating sleep induction bed according to claim 1, wherein said oscillating section is supported relative to said support section through a sliding surface formed using a low friction material.

4. The oscillating sleep induction bed according to claim 1, wherein said oscillating section is supported relative to said support section through a plurality of rollers or ball rollers.

5. The oscillating sleep induction bed according to claim 1, wherein said oscillating section is supported so as to slide on two or more guide rails extending in the lateral direction along an upper curved surface of said upper-surface curved section.

6. The oscillating sleep induction bed according to claim 1, wherein said drive means is a combination of a linear servo motor and a link mechanism.

7. The oscillating sleep induction bed according to claim 1, wherein said drive means is equipped with a winch mechanism.

8. The oscillating sleep induction bed according to claim 1, wherein a hanging means for supporting said oscillating section in a pendulum-like manner along said upper-surface curved section is included.
